(19) United States
(12) Patent Application Publication
(10) Pub. No.: US 2017/0071206 A1
(43) Pub. Date: Mar. 16, 2017

(54) ISOTHIAZOLlN-3-0NE-CONTAINING ANTIMICROBIAL COMPOSITION

(71) Applicant: ARCH WOOD PROTECTION, INC., Atlanta, GA (US)

(72) Inventors: Sungmee Choi, Cheshire, CT (US); Radu Craciun, Carmel, NY (US); Gareth Williams, York (GB); Katherine Roberts, Derby, CT (US)

(21) Appl. No.: 15/341,706

(22) Filed: Nov. 2, 2016

Related U.S. Application Data
(63) Continuation of application No. 11/846,019, filed on Aug. 28, 2007, now abandoned.
(60) Provisional application No. 60/843,046, filed on Sep. 8, 2006.

(51) Int. Cl. A01N 43/80; A01N 33/04; A01N 55/02; A01N 25/12; A01N 59/20

(52) U.S. Cl. CPC A01N 43/80; A01N 25/12; A01N 59/20; A01N 55/02; A01N 33/04

(57) ABSTRACT

The present invention relates to an antimicrobial composition that includes at least one isothiazolin-3-one and at least one alkyl amine containing a primary, secondary or tertiary amine functional group and having an average chain length of between eight and eighteen carbons per molecule of the alkyl amine.

### CROSS REFERENCE TO RELATED APPLICATIONS

This application is a Continuation of U.S. patent application Ser. No. 11/846,019, filed Aug. 28, 2007 which claims the benefit of U.S. Provisional Application No. 60/843,046, filed on Sep. 8, 2006, the contents of each of which are incorporated herein by reference.

### FIELD OF THE INVENTION

This invention relates to a composition for use as a wood preservative and a method for treating wood with the composition. More specifically, this invention relates to a composition that includes at least one alkyl amine and at least one isothiazolin-3-one, and a method for treating wood using this composition.

### DESCRIPTION OF THE RELATED ART

Isothiazolin-3-ones are known antimicrobial compounds that are suitable for use as wood preservatives. Illustratively, European patent publication EP 1283096A1 to Shinto Fine Co., Ltd, discloses the use of a composition comprising 2-n-octyl-4-isothiazolin-3-one (“OIT”) and N-n-butyl-1,2-benzisothiazolin-3-one (“BBIT”) for providing antifungal efficacy to a wood preservative composition including copper oxide or a copper salt and a fungicidal azole compound.

One drawback heretofore associated with wood preservative compositions containing isothiazolin-3-ones, such as OIT or BBIT, or a combination thereof, is the preservative compositions are less efficacious at a cost effective level in inhibiting mold growth than otherwise might be desired. The present invention provides a solution to this problem.

### BRIEF SUMMARY

One aspect of the present invention is an antimicrobial composition concentrate comprising at least one isothiazolin-3-one in an amount of between about 0.1 wt. % and about 40 wt. % based on the weight of the antimicrobial composition concentrate; at least one alkyl amine in an amount of between about 2 wt. % and about 80 wt. % based on the weight of the antimicrobial composition concentrate, wherein said alkyl amine comprises an average chain length of between 8 and 18 carbons per molecule of the alkyl amine; a surfactant present in an amount of between about 1 wt. % and about 50 wt. % based on the weight of the antimicrobial composition concentrate; and a solvent present in an amount of between about 1 wt. % and about 30 wt. % based on the weight of the antimicrobial composition concentrate.

Another aspect of the invention is a composition for imparting antimicrobial efficacy to a substrate, the composition comprising an isothiazolin-3-one in an amount of between about 0.001 wt. % and about 1.0 wt. % based on the weight of the composition; an alkyl amine in an amount of between about 0.02 wt. % and about 2.0 wt. % based on the weight of the composition; a surfactant in an amount of between about 0.01 wt. % and about 0.50 wt. % based on the weight of the composition; and a solvent in an amount of between about 0.01 wt. % and about 0.30 wt. % based on the weight of the composition.

Still another aspect of the invention is a method of treating a substrate to provide antifungal and anti-mold growth efficacy to the substrate, the method comprising: contacting the substrate with an antimicrobial composition, the antimicrobial composition comprising: a copper containing compound; at least one isothiazolin-3-one in an amount of between about 0.001 wt. % and about 1.0 wt. % based on the weight of the composition; an alkyl amine in an amount of between about 0.02 wt. % and about 2.0 wt. % based on the weight of the composition; a surfactant in an amount of between about 0.01 wt. % and about 0.50 wt. % based on the weight of the composition; and a solvent in an amount of between about 0.01 wt. % and about 0.30 wt. % based on the weight of the composition, wherein said antimicrobial composition provides antifungal and anti-mold growth efficacy to the substrate.

Yet another aspect of the present invention is a preservative composition comprising the composition comprising an isothiazolin-3-one in an amount of between about 0.001 wt. % and about 1.0 wt. % based on the weight of the composition; an alkyl amine in an amount of between about 0.02 wt. % and about 2.0 wt. % based on the weight of the composition; a surfactant in an amount of between about 0.01 wt. % and about 0.50 wt. % based on the weight of the composition; and a solvent in an amount of between about 0.01 wt. % and about 0.30 wt. % based on the weight of the composition; and a copper-containing compound.

Still a further aspect of the present invention is a composition comprising at least one isothiazolin-3-one; and at least one alkyl amine comprising a primary, secondary or tertiary amine functional group, wherein said alkyl amine comprises an average chain length of between 8 and 18 carbons per molecule of the alkyl amine.

These and other aspects will become apparent upon reading the following detailed description of the invention.

### DETAILED DESCRIPTION

The present invention relates to a composition that includes at least one isothiazolin-3-one (also known as “isothiazolone”), and at least one alkyl amine containing a primary, secondary or tertiary amine functional group, wherein the alkyl amine has a chain length of between eight and eighteen carbons per molecule of alkyl amine. A surfactant can be admixed with this composition an amount effective to form a microemulsion or microdispersion of the at least one isothiazolin-3-one, and at least one alkyl amine. Optionally a solvent, such as an organic solvent can be incorporated to the composition containing the at least one isothiazolin-3-one and at least one alkyl amine.

The composition provides enhanced antimicrobial efficacy, notably in inhibiting mold growth and growth of other microbes, as compared to compositions containing only the isothiazolin-3-one or the alkyl amine individually. The composition is particularly suitable in applications such as wood preservation.

The composition may be utilized as a concentrate, which may subsequently be diluted to form a diluted composition for use as a functional fluid, such as a wood preservative fluid. The composition concentrate may be admixed with a preservative compound, such as a copper-containing preservative compound, and other components, such as water. Typically the composition concentrate is diluted by admixing it with an aqueous and/or organic solvent. The composition concentrate to solvent is typically in a ratio of 1:10 to 1:800. Preferably, the composition concentrate and solvent are in a weight ratio of 1:100.

The diluted composition contains between about 0.001 wt. % to 1.0 wt. % of the isothiazolin-3-one, and the other components of the composition concentrate are proportionately diluted to form the diluted composition for use in the functional fluid.

The presence of the alkyl amine in these compositions permits usage of lower amounts of the isothiazolin-3-one(s) to provide the desired antimicrobial efficacy at a cost effective level, particularly antifungal and anti-mold efficacy, than otherwise would be needed in the absence of the alkyl amine. This is particularly advantageous in view of the lower cost of the alkyl amine, as compared to the cost associated with the isothiazolin-3-one(s).

It is contemplated that any isothiazolin-3-one may be used in the present invention. However, 2-n-octyl-4-isothiazolin-3-one (hereinafter referred to as OIT) and N-n-butyl-1,2-benzisothiazolin-3-one (hereinafter referred to as BBIT) are examples of isothiazolin-3-ones that are particularly useful, either separately or in combination with each other.

In one embodiment of the composition, only one isothiazolin-3-one is present. For example, the composition can contain either OIT or BBIT. In another embodiment of the composition, more than one isothiazolin-3-one may be used. For example, the composition can contain both OIT and BBIT. Similarly, the composition concentrate may contain either one or a combination of both isothiazolin-3-ones.

If two isothiazolin-3-ones are utilized in the composition, the weight ratio of one isothiazolin-3-one to the other isothiazolin-3-one is typically between 1:50 and 50:1, depending on the application the composition is being utilized for. The weight ratio of one isothiazolin-3-one to the other isothiazolin-3-one may also be between 1:1 to 2:1. Illustratively, when OIT and BBIT are both present in the composition, a suitable weight ratio of OIT to BBIT within the above-mentioned range may be 2:1, but the weight ratio can vary, depending upon the application that is envisioned.

In the composition concentrate, the isothiazolin-3-one(s) is typically present in an amount of between about 0.1 wt. % to about 40.0 wt. % based on the total weight of the composition concentrate. After dilution of the composition concentrate to form the functional fluid, the isothiazoline-3-one(s) are present in an amount of between about 0.001 wt. % to about 1.0 wt. %, based on the weight of the composition.

More specifically, when OIT and BBIT are used in combination at a weight ratio of 2: 1, OIT is present in the diluted composition in an amount of between about 0.003 wt. % to about 0.005 wt. %, or 30-50 ppm, while BBIT is present in the functional fluid in an amount of between about 0.0015 wt. % to about 0.0025 wt. %, or 15-25 ppm.

Also included in the composition and composition concentrate is an alkyl amine containing a primary, secondary or tertiary amine functional group, having between eight and eighteen carbons per molecule of alkyl amine. A surprising and unexpected synergism between the isothiazolin-3-one(s) and the alkyl amine has been found. While the inventors do not wish to be bound by any particular theory, it is believed the synergism results in an increase in the antimicrobial efficacy of the composition in comparison to compositions containing only an isothiazolin-3-one or only an alkyl amine. The antimicrobial efficacy of the compositions is increased when the alkyl amine has a chain length of between eight and eighteen carbons per molecule of alkyl amine.

The alkyl amines suitable for use in the compositions of the present invention may have a straight or branched chain. Although primary, secondary or tertiary alkyl amines are suitable for use in the compositions, particularly useful alkyl amines are the tertiary alkyl amines. Tertiary alkyl amines having methyl- or ethyl-substituents together with a longer chain substituent having an average chain length of between eight and eighteen carbons per molecule of the alkyl amine may be advantageous. Particularly preferred are the alkyl-, dimethyl-amines wherein the alkyl group has an average chain length of eight to eighteen carbons per molecule. As illustrated in the examples included herein, compositions of the present invention containing alkyl-, dimethyl amines wherein each alkyl moiety has twelve carbons (“C-12 alkyl amines”) exhibit enhanced antimicrobial efficacy as compared to compositions not containing the amines. An example of a suitable alkyl amine is a dodecyl alkyl amine, sold under the name of Barlene 12S, supplied by Lonza Group, Switzerland. Likewise, another suitable dodecyl alkyl amine, sold under the name Macat C12 amine, supplied by Mason Chemical of Illinois, USA.

When the alkyl amine is used in combination with a single isothiazolin-3-one, the weight ratio of the single isothiazolin-3-one to alkyl amine is between 1:1 and 1:800. Preferably, the weight ratio of isothiazolin-3-one to alkyl amine is between 1:1 and 1:40, and more preferably the weight ratio is between 1:6 and 1:12.

When more than one isothiazolin-3-one compound is present in the composition, the weight ratio of the total isothiazolin-3-ones to alkyl amine is between 1:1 to 1:800. Preferably, in one embodiment of the composition the weight ratio of total isothiazolin-3-ones to alkyl amine is between about 1:10 and about 1:20.

In the composition concentrate, the alkyl amine is typically present in an amount of from about 2.0 wt. % to about 80.0 wt. % based on the total weight of the composition concentrate. When diluted to form the functional fluid, the alkyl amine is typically present in an amount of between about 0.02 wt. % to about 2.0 wt. %, based on the weight of the composition. Typically, the alkyl amine is present in the diluted composition in an amount of between about 0.2 wt. % to about 0.3 wt. %, or 2000 ppm to 3000 ppm.

The isothiazolin-3-one(s) and alkyl amines present in the composition are generally admixed by means known in the art. To prepare the composition concentrate, the isothiazolin-3-one(s) and alkyl amines may be used in combination with one or more solvents and surfactants. The solvents and surfactants are present in the composition concentrate in a weight ratio between 1:1 and 5:1.

Typically, the solvents and surfactants are present in the composition concentrate in an amount of between about 1 wt. % to about 55 wt. % based on the weight of the composition concentrate. Similarly, when diluted to form the finctional fluid, the solvents and surfactants are present in an amount of between about 0.01 wt. % to about 0.55 wt. %

based on the weight of the composition when the composition concentrate is diluted in a weight ratio of 1:100.

The composition concentrate may contain one or more solvents that are useful in dissolving the isothiazolin-3-one(s). Useful solvents include organic solvents, including alcohols such as methanol and ethanol, amines such as diethanolamine, glycols or ethoxylated glycols, ethers, esters, and the like. Typical organic solvents used in the present invention include dipropylene glycol 2-methyl-ether and monoethanolamine (MEA). Typically the solvent is present in the composition concentrate in an amount of between about 1 wt. % to about 30 wt. % based on the total weight of the composition concentrate. Similarly, when diluted to form the functional fluid, the solvent is present in an amount of between 0.01 wt. % to about 0.30 wt. % based on the total weight of the diluted composition when the composition concentrate is diluted in a weight ratio of 1:100.

A surfactant may help maintain an isothiazolin-3-one/solvent microemulsion when the composition concentrate is used in its diluted form. Useful surfactants include anionic surfactants, cationic surfactants, nonionic surfactants, amphoteric surfactants, and combinations thereof. Useful nonionic surfactants include linear alcohol alkoxylates, such as the linear alcohol ethoxylates, ethoxylated/propoxylated block copolymers, ethoxylated/propoxylated fatty alcohols, and polyoxyethylene cetyl ethers, and the like. Useful linear alcohol alkoxylates are commercially available, for example, under the registered trademark POLY-TERGENT SL-42, a product of Arch Corporation. Other useful nonionic surfactants include one commercially available as NEODOL 91-6, a trademarked surfactant product of Shell Chemical. This surfactant is a detergent range mixture of C9-C11 linear primary alcohol ethoxylates having an average of six moles of ethylene oxide per mole of alcohol. Other useful nonionic surfactants include those containing a linear C9-C11 carbon chain and five or six ethylene oxide or propylene oxide groups per molecule. Useful anionic surfactants include alkyl diphenylether disulfonates, alkyl phenyl ethoxylated phosphate esters, carboxylated linear alcohol alkoxylates, linear alkyl benzene sulfonic acid, diisobutyl sulfosuccinate, abietic acid and alkyl sulfonates.

Other useful anionic surfactants are polycarboxylated alcohol alkoxylates, preferably those selected from the group consisting of the acids or organic or inorganic salts of the following: polycarboxylated linear alcohol alkoxylates, polycarboxylated branched alcohol alkoxylates, polycarboxylated cyclic alcohol alkoxylates, and combinations thereof. Although individually the cationic and the amphoteric surfactants are acceptable for use in the process of the present invention, it is preferred that they be used in combination with at least one surfactant from one of the other classes. Illustrative cationics include alkyl triammonium halide, non-linear alkyl dimethyl halide and alkyl dimethyl benzyl ammonium halide containing surfactants. Illustrative amphoteric surfactants include polyglycol ether derivatives, ethoxylate oxazolin derivatives, lauramidopropyl betain and lecithin.

Blends or combinations of the above-described surfactants can be used in the compositions of the present invention. Such a blend can be any combination of two or more surfactants, between or within the above-described four broad classes of surfactants. Combinations can include blends of: anionic with anionic, anionic with nonionic, anionic with cationic, anionic with amphoteric, cationic with cationic, cationic with amphoteric, nonionic with nonionic, nonionic with amphoteric, and amphoteric with amphoteric. Likewise, ternary and quaternary blends of surfactants by selecting three or four surfactants, respectively, from within or among the above-described classes. The surfactant(s) are suitably employed in the concentrates of the present invention in an amount of between about 1.0 wt. % to about 50 wt. % based on the total weight of the composition concentrate. Similarly, when diluted to form the functional fluid, the surfactant is present in an amount of between about 0.01 wt. % to about 0.50 wt. % based on the total weight of the diluted composition when the composition concentrate is diluted in a weight ratio of 1:100.

The composition described above is surprisingly effective as an antimicrobial, i.e., the compositions impart antifungal or biocidal properties to any product or material the composition is contacted with. The composition concentrate may be applied in its concentrated form, or may be diluted before using. The composition and the composition concentrate can be diluted to form a functional fluid by admixing with aqueous and/or organic solvents. The functional fluid can be, for example, a wood preservative, a paint or a metal-working fluid.

Typically, in use, the composition concentrate is diluted by admixing it with an aqueous solvent and/or an organic solvent. The weight ratio of dilution of the composition concentrate to solvent is typically 1:10 to 1:800.

In addition, the diluted composition may contain a copper-containing antimicrobial compound. The copper could be one of the following: copper metal, copper oxide, copper hydroxide, various inorganic or organic copper complexes such as Cu-ethanolamine, Cu-dimethyl-dithio-carbamate (CDDC), Cu-sulfates, Cu-2-ethyl-hexanoate, Cu-quaternary alkyl-ammonium, Cu(OH).sub.2, BCC (basic copper carbonate), Cu-nitrate, Copper-8-quinolinolate, Cu-bentains, or Cu-HDO, of various particle size distribution. The copper may have a particle size of between about 0.001 micron and about 10 microns.

Alternatively, the diluted composition can contain any component that is effective in facilitating the application of the composition to a substrate.

The copper is typically present in the diluted composition in an amount of between about 0.01 wt. % to about 5 wt. %, based on the weight of the diluted composition. The remainder of the diluted composition is typically water and other optional components such as pigments, co-biocides, and the like.

The functional fluid may also contain other optional additives, including but not limited to: a co-surfactant; water; dyes; and co-biocides. Suitable co-biocides include, for example, tebuconazole, propiconazole or other azoles, such as copper azole; chlorothalonil, copper ethanolamine, copper oxides, copper bicarbonate, copper-2-ethylhexanoate, copper-ethyl-aceto-acetate, and copper dimethyl-dithio-carbamate. If used, the optional co-biocides are suitably employed in the functional fluid in a range of amounts of from 0.1 wt. % to 60 wt. % based on the total weight of the diluted composition. The amount of these co-biocides may vary based on application or use.

The composition concentrate and the functional fluid can be contacted with and applied to any substrate such as wood, wood-containing products or other substrates such as gypsum, wall board, fiberboard, plastic, plaster board, fiberglass, and the like, and combinations thereof, that may experience mold or bacterial growth problems.

Both the composition concentrate and the diluted version thereof, can be applied to such products and materials in any manner known in the art, including, but not limited to: pressure treatment; vacuum treatment; sprays; spritzs; dips; immersion; injection; and the like.

Alternatively, the composition, the composition concentrate or the diluted composition may be blended with precursors of the materials or products that are sought to be protected from fungus or microbes, i.e., the composition may be incorporated directly into the material or product during its manufacture.

The composition concentrate and diluted forms thereof have shown improved efficacy against certain microbes, including, but not limited to, various bacterial species and mold species. While the inventors do not wish to be limited to one theory regarding the mechanism of the present invention, it is believed the alkyl amine attaches to, and forms a layer in or on the substrate to which the composition is applied. The attachment of the alkyl amine to the substrate facilitates the imparting of improved resistance to microbial growth on the substrate in the presence of isothiazolin-3-one(s), which otherwise will be strongly bonded to the substrate and eventually becomes biologically inactive.

The antimicrobial efficacy associated with compositions containing a combination of an alkyl amine containing a primary, secondary or tertiary amine functional group, and OIT or BBIT, is illustrated the following examples.

The present invention is further described in detail by means of the following Examples and Comparisons. All parts and percentages are by weight and all temperatures are degrees Celsius unless explicitly stated otherwise.

### EXAMPLES

### Example 1

### Part A. Preparation of Composition Concentrates:

Examples of composition concentrate formulations are provided in Table 1, where the average amount of isothiazolin-3-one(s) is about 6.3 wt. % based on the weight of the composition concentrate. OIT was added to the composition concentrate as a 45 wt. % alcohol-based solvent solution, while BBIT was added to the composition concentrate as a 92 wt. % alcohol based solvent solution.

The composition concentrate formulations shown in Table 1 contain a solvent and a surfactant. In this example, dipropylene glycol 2-methyl ether is used as an organic solvent and ethoxylated castor oil is employed as a surfactant. The solvent and the surfactant, together with a slight agitation at room temperature, stabilize the isothiazolin-3-one(s) and form a homogeneous system when combined with the alkyl amine.

The alkyl amine used in the composition concentrates in this example is a C12-alkyl amine known as Barlene 12S, which is manufactured by Lonza Group, Switzerland.

The composition concentrates are miscible in water and are compatible with copper-based wood preservative systems that are used in the industry. TABLE-US-00001 TABLE 1 Composition concentrates containing BBIT and/or OIT in combination with an alkyl amine Concentrate 3 Concentrate 1 Concentrate 2 (3.15% OIT+(6.3% BBIT) (6.3% OIT) 3.15.% BBIT) INGREDIENTS [grams] [grams] [grams] C12-Dodecyl alkyl 30.00 30.00 30.00 amine (Barlene 12S) OIT—45%—14.00 7.00 BBIT—92% 6.85—3.42 Ethoxylated 10.00 10.00 10.00 Castor Oil Dipropylene glycol 2—30.00 25.00 30.00 methyl-ether Water 23.15 21.00 19.58 Total 100.00 g 100.00 g 100.00 g

Part B. Preparation of a Diluted form of the Composition Concentrates

In table 2, a composition concentrate was diluted by admixing the concentrate with a copper containing formulation and water. Various concentrations of the composition concentrate were added to the a copper containing formulation and water under slight agitation.

In this diluted composition, the isothiazolin-3-one(s) is typically present in an amount of between about 0.035 wt. % to about 0.07 wt. % based on the total weight of the diluted composition. TABLE-US-00002 TABLE 2A Composition Concentrates diluted in the presence of Cu-MEA: Composition Composition Composition Composition Composition Composition A0 B0 C0 D0 E0 F0 INGREDIENTS [wt. %] [wt. %] [wt. %] [wt. %] [wt. %] [wt. %] C12-Alkyl 0.2—0.2 0.2 0.2 Amine (Barlene 12S) OIT—0.07—0.07—0.035 BBIT—0.07—0.07 0.035 Cu-ethanol-3.0 3.0 3.0 3.0 3.0 3.0 Amine (MEA solvent) ethoxylated 0.15 0.15 0.15 0.15 0.15 0.15 Castor oil (surfactant) Water 96.65 96.78 96.78 96.58 96.58 96.58 Total 100.00 100.00 100.00 100.00 100.00 100.00

As shown in Table 2A, the composition concentrates containing monoethanolamine (MEA) as a solvent and ethoxylated Castor oil as a surfactant were added to a copper containing formulation to form copper ethanolamine. As shown in the table, the weight ratio of isothiazolin-3-one to alkyl amine is between about 1:2 to about 1:3.

Upon visual observation, compositions A0-F0 were either clear or slightly hazy. TABLE-US-00003 TABLE 2B Proposed Diluted Compositions of Composition Concentrates without Cu-MEA: Composition Composition Composition Composition Composition Composition A1 B1 C1 D1 E1 F1 INGREDIENTS [wt. %] [wt. %] [wt. %] [wt. %] [wt. %] [wt. %] C12-Alkyl 0.2—0.2 0.2 0.2 Amine (Barlene 12S) OIT—0.07—0.07—0.035 BBIT—0.07—0.07 0.035 Propylene 1.0 1.0 1.0 1.0 1.0 1.0 Glycol (solvent) ethoxylated 0.15 0.15 0.15 0.15 0.15 0.15 Castor oil (surfactant) Water 98.65 98.78 98.78 98.58 98.58 98.58 Total 100.00 100.00 100.00 100.00 100.00 100.00

In Table 2B, composition concentrates can contain propylene glycol as a solvent and ethoxylated Castor oil as a surfactant. To form a functional fluid, the composition concentrates would be diluted in water. A copper containing formulation would not be added to this functional fluid.

### Example 2

To determine the effectiveness of compositions containing an alkyl amine in combination with OIT and/or BBIT, such compositions were compared to compositions containing only an alkyl amine or compositions containing only OIT or BBIT. The efficacy of those compositions was shown by applying the compositions to Southern Yellow Pine (SYP) wood samples.

After the SYP samples were treated with the particular composition to be evaluated, the samples were placed onto a support in an extra depth Petri-dish.

A fungal spore suspension of two common mold species (Aspergillus and Fusarium) was spread on top of the wood sample. Fungal hyphal growth on the surface of samples was examined under the microscope once every week. The scale based on mycelial coverage of wood surface is as follows: TABLE-US-00004 0 0% 1 <10% 2 .about.10-30% 3 .about.30-60% 4 >60%

Efficacy of Compositions Containing Alkyl Amine in Combination with OIT, BBIT or OIT and BBIT

To evaluate the effectiveness of the compositions against common species of mold, compositions containing various levels of BBIT, OIT and C12-alkyl amine or a mixture of these components were tested on SYP wood blocks using the testing protocol discussed above. Specifically, compositions shown in Table 2A were applied to the wood blocks to determine anti-fungal efficacy of the compositions.

It is noted that compositions containing OIT and C12-alkyl amine were obtained by mixing compositions A0 and B0 in the recited ratio. Likewise, compositions containing BBIT and C12-alkyl amine were obtained by mixing compositions A0 and C0 . TABLE-US-00005 TABLE 3 Effect of OIT and BBIT in the combination with alkyl amine on mold control. Components Ratio Conc. (ppm) Aspergillus sp Fusarium sp Control 4.sup..dagger-dbl., 4, 4, 4 1, 3, 3, 4 OIT alone 1:0 100 0*, 0, 1, 1 0, 0, 0, 0 OIT: C12-alkyl 1:5 50:250 0, 1, 1, 2 0, 0, 0, 0* amine 65:3250, 0, 1, 1 0, 0, 0, 0* 75:375 0, 0, 0, 0 0, 0, 0, 0 1:10 38:380 0, 1, 2, 3 0, 1, 1, 1* 50:500 0, 1, 1, 2 0, 0, 0, 0 63:630 0, 0, 0, 0 0, 0, 0, 0 1:20 25:500 0, 1, 1, 2 0, 0, 0, 0* 31:625 0, 1, 2, 2 0, 0, 0, 0 38:750 0, 0, 0, 0 0, 0, 0, 0 C12-alkyl amine 0:1 1000 0, 2, 3, 3 0, 0, 0, 0 alone BBIT: C12-alkyl 1:6.25 40:250 0, 1, 1, 2 0, 0, 0, 1* amine 50:313 0, 0, 0, 1 0, 0, 0, 0* 60:375 0, 0, 0, 0 0, 0, 0, 0* 1:12.5 40:500 0, 0, 0, 1 0, 0, 0, 0 50:625 0, 0, 0, 0 0, 0, 0, 0* 1:25 20:500 0, 1, 2, 2 0, 1, 1, 1* 25:625 0, 1, 1, 2 0, 0, 0, 0* 30:750 0, 0, 1, 1 0, 0, 0, 0 BBIT alone 1:0 80 0, 0, 0, 1 0, 0, 1, 1 .sup..dagger-dbl.Values represent the average of mycelial coverage from 3 replicates at 1 week, 2 weeks, 3 weeks, and 4 weeks of incubation. Values were rounded up to one place. Scale based on mycelial coverage of wood surface—0: none, 1: <10%, 2: 10.about.30%, 3: 30.about.60%, 4: >60% *Bacteria were observed on the bottom surface where contacted with a support.

Different concentrations of OIT, BBIT and alkyl amine were tested. Additionally, various ratios of isothiazolin-3-one versus amine were tested to screen and evaluate the optimum ratio for the compositions. It was observed that OIT and BBIT were well dispersed, and formed a homogeneous solution when the alkyl amine was used to prepare the compositions.

Table 3 shows the efficacy of compositions containing alkyl amine alone, BBIT alone, OIT alone, or an alkyl amine in combination with either OIT or BBIT. As shown in

Table 3, OIT alone at a concentration of 100 ppm, and BBIT alone at a concentration of 80 ppm, performed effectively as a moldicide. The C12-alkyl amine, used alone at a concentration of 1000 ppm also performed effectively as a moldicide against Fusarium but was less effective against Aspergillus.

The combination of either OIT or BBIT with a C 12-alkyl amine was also efficacious as a moldicide. However, the concentrations of each component when used in combination were significantly less than the concentrations when the components were used alone.

For example, when OIT and the C12-alkyl amine were used in a weight ratio of 1:5 at concentrations of 75 ppm and 375 ppm, respectively, that composition was just as effective as a moldicide as compared to using OIT or the alkyl amine alone. Antifungal efficacy is similar in a composition containing a combination of BBIT and a C12-alkyl amine.

Therefore, combining smaller concentrations of OIT or BBIT with smaller concentrations of an alkyl amine results in compositions that are just as effective in mold control as compared to those compositions containing higher concentrations of only alkyl amine or compositions containing higher concentrations of only OIT or BBIT.

Thus, based on these results, when an alkyl amine is added to the composition, less OIT or BBIT is required to obtain the same level of antimicrobial efficacy. Reduction in the amount of OIT or BBIT used in the compositions will decrease the cost associated in producing these compositions.

Additionally, it is noted that the combination of alkyl amine and either OIT or BBIT had an increased efficacy against the Aspergillus spore type of mold as compared to when either OIT or BBIT was used alone. Utilizing a composition containing a 1:5 weight ratio of OIT to alkyl amine at a concentration of 75 ppm and 375 ppm, respectively, was more effective against Aspergillus than utilizing a composition containing only 100 ppm of OIT.

Similarly, utilizing a composition containing a 1:12.5 weight ratio of BBIT to alkyl amine at a concentration of 50 ppm and 625 ppm, was more effective against Aspergillus than utilizing a composition containing only 80 ppm of BBIT.

Table 4, shown below, illustrates the efficacy of a composition containing an alkyl amine in combination with both OIT and BBIT. The compositions containing OIT, BBIT and an alkyl amine are compared to a control (water), alkyl amine alone, OIT alone and BBIT alone. TABLE-US-00006 TABLE 4 The effect of the combination of OIT, BBIT and alkyl amine on mold control. Ratio Concentration Aspergillus (OIT:BBIT):alkyl amine (ppm) sp Fusarium sp Control 4.sup..dagger-dbl., 4, 4, 4 1, 1, 2, 3 C12-alkyl amine alone 1000 0, 2, 3, 3 0, 0, 0, 0 (2:1):100 (7:3.5):700 0, 1, 2, 2 0, 0, 1, 1 (8:4):800 0, 0, 0, 1 0, 0, 0, 0 (10:5):960 0, 0, 0, 0 0, 0, 0, 0 (2:1):96 (13:6.5):624 0, 0, 0, 1 0, 0, 1, 1* (15:7.5):720 0, 0, 0, 1 0, 0, 0, 0* (17:8.5):816 0, 0, 0, 0 0, 0, 0, 0 (2:1):48 (20:10):480 0, 0, 1, 2 0, 0, 0, 1* (23:11.5):5520, 1, 1, 2 0, 0, 0, 0* (25:12.5):600 0, 0, 0, 0 0, 0, 0, 0* (2:1):24 (30:15):360 0, 0, 0, 0 0, 0, 0, 0 (33:16.5):396 0, 0, 0, 0 0, 0, 0, 0* (38:19):456 0, 0, 0, 0 0, 0, 0, 0 (2:1):12 (33:16.5):198 0, 1, 1, 1 0, 0, 0, 0 (38:19):228 0, 0, 0, 0 0, 0, 0, 0* (42:21):252 0, 0, 0, 0 0, 0, 0, 0 (2:1) of OIT:BBIT 100:50 0, 0, 0, 0 0, 0, 0, 0 (no C12-alkyl amine used) 80:40 0, 0, 0, 0 0, 0, 0, 0 2.3:1 OIT:BBIT 77:33 0, 0, 1, 2 0, 0, 0, 0 1.94:1 OIT:BBIT 50:25 1, 1, 2, 3 0, 0, 1, 3 33:17 1, 2, 3, 4 0, 1, 1, 3 .sup..dagger-dbl.Values represent the average of mycelial coverage from 3 replicates at 1 week, 2 weeks, 3 weeks, and 4 weeks of incubation. Values were rounded up to one place. Scale based on mycelial coverage of wood surface—0: none, 1: <10%, 2: 10.about.30%, 3: 30.about.60%, 4: >60% *Bacteria were observed on the bottom surface where contacted with a support.

The compositions containing high concentrations of OIT and BBIT, with no alkyl amine present, were extremely effective in controlling mold growth. However, compositions containing low concentrations of OIT and BBIT did not perform as effectively as those compositions containing higher concentrations. (See results for compositions containing OIT:BBIT of 50:25 and 33:17).

The efficacy of compositions containing lower concentrations of OIT:BBIT is increased when an alkyl amine is added to the composition. In fact, the efficacy of compositions with lower concentrations of OIT and BBIT when used in combination with alkyl amine containing a primary, secondary or tertiary amine functional group, is comparable to the efficacy of compositions containing high concentrations of OIT and

BBIT without alkyl amine. Similarly, when alkyl amino is used alone, its mold control efficacy is not as effective as the efficacy of compositions having high concentrations of OIT and BBIT.

Accordingly, a clear synergism is shown between the OIT:BBIT mixture and the C12-alkyl amine. Such synergism is believed to increase the antimicrobial efficacy of the composition. As such, a composition can be produced which contains the OIT:BBIT mixture and the alkyl amine containing a primary, secondary or tertiary amine functional group, which is a more cost effective composition as compared to compositions containing only the OIT:BBIT mixture.

Overall, the combination of alkyl amine and OIT or BBIT or OIT and BBIT performed effectively. The example containing a 1:5 weight ratio of OIT:alkyl amine and the example containing a 1:6.5 weight ratio of BBIT:alkyl amine appeared to have the greatest antimicrobial efficacy of the examples tested. For the ternary system, BBIT:OIT:alkyl amine at (2:1):24 ratio exhibited the best antimicrobial efficacy.

1. An antimicrobial composition concentrate comprising:
at least one isothiazolin-3-one in an amount of between about 0.1 wt. % and about 40 wt. % based on the weight of the antimicrobial composition concentrate, wherein said isothiazolin-3-one is selected from the group consisting of 2-n-octyl-4-isothiazolin-3-one, N-n-butyl-1,2-benzisothiazolin-3-one and a combination thereof;
at least one alkyl amine in an amount of between about 2 wt. % and about 80 wt. % based on the weight of the antimicrobial composition concentrate, wherein said alkyl amine comprises a tertiary amine having methyl or ethyl-substituents together with a long chain substituent having an average chain length of 12 carbons per molecule of the tertiary amine;
at least one surfactant present in an amount of between about 1 wt. % and about 50 wt. % based on the weight of the antimicrobial composition concentrate; and
at least one solvent present in an amount of between about 1 wt. % and about 30 wt. % based on the weight of the antimicrobial composition concentrate, wherein when the isothiazolin-3-one consists of 2-n-octyl-4-isothiazolin-3-one, the weight ratio of the 2-n-octyl-4-isothiazolin-3-one to the alkyl amine is between 1:5 and 1:20; when the isothiazolin-3-one consists of N-n-butyl-1.2-benzisothiazolin-3-one, the weight ratio of the N-n-butyl-1.2-benzisothiazolin-3-one to the alkyl amine is between 1:6.25 and 1:25; when the alkyl amine is used in combination with both 2-n-octyl-4-isothiazolin-3-one, and N-n-butyl-1,2-benzisothiazolin-3-one, the weight ratio of the sum of the 2-n-octyl-4-isothiazolin-3-one and the N-n-butyl-1.2-benzisothiazolin-3-one to the alkyl amine is between about 1:10 and about 1:20, and the weight ratio of the 2-n-octyl-4-isothiazolin-3-one to the N-n-butyl-1,2-benzisothiazolin-3-one is between 1:1 and 2:1.

2. The antimicrobial composition of claim 1, wherein said solvent is selected from the group consisting of: dipropylene glycol 2-methyl-ether, monoethanolamine, propylene glycol and combinations thereof, and said surfactant is selected from the group consisting of alkyl diphenylether disulfonates, alkyl phenyl ethoxylated phosphate esters, carboxylated linear alcohol alkoxylates, linear alkyl benzene sulfonic acid, diisobutyl sulfosuccinate, abietic acid, alkyl sulfonates, polyoxyethylene cetyl ether, ethoxylated castor oil, and combinations thereof, wherein the solvent and surfactant are present in the antimicrobial composition in a weight ratio between 1:1 and 5:1.

3. A composition for imparting antimicrobial efficacy to a substrate, the composition comprising:
at least one isothiazolin-3-one in an amount of between about 0.001 wt. % and about 1.0 wt. % based on the weight of the composition, wherein said isothiazolin-3-one is selected from the group consisting of 2-n-octyl-4-isothiazolin-3-one, N-n-butyl-1,2-benzisothiazolin-3-one and a combination thereof;
at least one alkyl amine in an amount of between about 0.02 wt. % and about 2.0 wt. % based on the weight of the composition, wherein said alkyl amine comprises a tertiary amine having methyl or ethyl-substituents together with a long chain substituent having an average chain length of 12 carbons per molecule of the tertiary amine;
at least one surfactant in an amount of between about 0.01 wt. % and about 0.50 wt. % based on the weight of the composition; and
at least one solvent in an amount of between about 0.01 wt. % and about 0.30 wt. % based on the weight of the composition, wherein when the isothiazolin-3-one consists of 2-n-octyl-4-isothiazolin-3-one, the weight ratio of the 2-n-octyl-4-isothiazolin-3-one to the alkyl amine is between 1:5 and 1:20; when the isothiazolin-3-one consists of N-n-butyl-1.2-benzisothiazolin-3-one, the weight ratio of the N-n-butyl-1.2-benzisothiazolin-3-one to the alkyl amine is between 1:6.25 and 1:25; when the alkyl amine is used in combination with both 2-n-octyl-4-isothiazolin-3-one, and N-n-butyl-1,2-benzisothiazolin-3-one, the weight ratio of the sum of the 2-n-octyl-4-isothiazolin-3-one and the N-n-butyl-1.2-benzisothiazolin-3-one to the alkyl amine is between about 1:10 and about 1:20, and the weight ratio of the 2-n-octyl-4-isothiazolin-3-one to the N-n-butyl-1,2-benzisothiazolin-3-one is between 1:1 and 2:1.

4. The composition according to claim 3, further comprising copper in an amount of between about 0.01 wt. % and about 5 wt. % based on the weight of the composition.

5. The composition according to claim 4, wherein the copper is present in the composition in a compound selected from the group consisting of copper metal, copper oxide, copper hydroxide, various inorganic or organic copper complexes such as Cu-ethanolamine, Cu-dimethyl-dithio-carbamate (CDDC), Cu-sulfates, Cu-2-ethyl-hexanoate, Cu-quaternary alkyl-ammonium, Cu(OH)₂, BCC (basic copper carbonate), Cu-nitrate, Copper-8-quinolinolate, Cu-bentains and Cu-HDO.

6. The composition according to claim 4, further comprising a co-biocide in an amount of between about 0.1 wt. % and about 60 wt. % based on the weight of the composition.

7. The composition according to claim 3, further comprising water.

8. A preservative composition comprising: the composition of claim 3; and a copper-containing compound.

9. The preservative composition of claim 7, wherein the copper is present in a copper compound selected from the group consisting of copper metal, copper oxide, copper hydroxide, various inorganic or organic copper complexes such as Cu-ethanolamine, Cu-dimethyl-dithio-carbamate (CDDC), Cu-sulfates, Cu-2-ethyl-hexanoate, Cu-quaternary alkyl-ammonium, Cu(OH)₂, BCC (basic copper carbonate), Cu-nitrate, Copper-8-quinolinolate, Cu-bentains and Cu-HDO.

10. The preservative compound of claim 9, wherein the copper compound has a particle size of between about 0.001 micron and about 10 microns.

11. A composition comprising: at least one isothiazolin-3-one selected from the group consisting of 2-n-octyl-4-isothiazolin-3-one, N-n-butyl-1,2-benzisothiazolin-3-one and a combination thereof;
and
at least one alkyl amine comprising a tertiary amine having methyl or ethyl-substituents together with a long chain substituent having an average chain length of 12 carbons per molecule of the tertiary amine, wherein when the isothiazolin-3-one consists of 2-n-octyl-4-isothiazolin-3-one, the weight ratio of the 2-n-octyl-4-isothiazolin-3-one to the alkyl amine is between 1:5 and 1:20; when the isothiazolin-3-one consists of N-n-butyl-1.2-benzisothiazolin-3-one, the weight ratio of the N-n-butyl-1.2-benzisothiazolin-3-one to the alkyl amine is between 1:6.25 and 1:25; when the alkyl amine is used in combination with both 2-n-octyl-4-isothiazolin-3-one, and N-n-butyl-1,2-benzisothiazolin-3-one, the weight ratio of the sum of the 2-n-octyl-4-isothiazolin-3-one and the N-n-butyl-1.2-benzisothiazolin-3-one to the alkyl amine is about 1:10 and about 1:20, and the weight ratio of the 2-n-octyl-4-isothiazolin-3-one to the N-n-butyl-1,2-benzisothiazolin-3-one is between 1:1 and 2:1.

12. The composition according to claim 11, further comprising a surfactant in an amount effective to form a micro emulsion or micro dispersion of said at least one isothiazolin-3-one and said at least one alkyl amine in the presence of water or optionally in the presence of an organic solvent.

13. The composition according to claim 11, in the form of a composition concentrate, wherein said at least one isothiazolin-3-one is present in an amount of between about 0.1 wt. % and about 40 wt. % based on the weight of the composition concentrate; and said at least one alkyl amine is present in an amount of between about 2 wt. % and about 80 wt. % based on the weight of the composition concentrate.

14. The composition according to claim 11, wherein said at least one isothiazolin-3-one is present in an amount of between about 0.001 wt. % and about 1.0 wt.% based on the weight of the composition; and said at least one alkyl amine is present in an amount of between about 0.02 wt. % and about 2.0 wt. % based on the weight of the composition.

15. The antimicrobial composition concentrate of claim 1, wherein the alkyl amine comprises an alkyl-, dimethyl amine wherein each alkyl moiety has twelve carbons.

16. The composition of claim 3, wherein the alkyl amine comprises an alkyl-, dimethyl amine wherein each alkyl moiety has twelve carbons.

17. The composition of claim 11, wherein the alkyl amine comprises an alkyl-, dimethyl amine wherein each alkyl moiety has twelve carbons.

18. The composition of claim 1 wherein the isothiazolin-3-one is 2-n-octyl-4-isothiazolin-3-one, and the weight ratio of 2-n-octyl-4-isothiazolin-3-one to alkyl amine is about 1:5.

19. The composition of claim 1 wherein the isothiazolin-3-one is N-n-butyl-1,2-benzisothiazolin-3-one, and the weight ratio of N-n-butyl-1,2-benisothiazolin-3-one to alkyl amine is about 1:6.5.
